(19) United States
(12) Patent Application Publication
(10) Pub. No.: US 2010/0054528 A1
(43) Pub. Date: Mar. 4, 2010

(54) Method for Producing and Visualizing an Optically Hidden Mark

(76) Inventor: Yuri Konstantinovich Nizienko, Moskovskaya Oblast (RU)

Correspondence Address: MILLER, MATTHIAS & HULL, ONE NORTH FRANKLIN STREET, SUITE 2350, CHICAGO, IL, 60606, US

(21) Appl. No.: 12/375,906

(22) PCT Filed: Aug. 4, 2006
(86) PCT No.: PCT/RU06/00412

§ 371 Date: Nov. 6, 2009

(51) Int. Cl. G06K 9/00

(52) U.S. Cl. 382/100

(57) ABSTRACT

The utility model can be used to visualize hidden images (marks) that are used to identify the object, thereby providing protection against forgery. The device includes means for cooling of the viewed object (VO), the mirror-like surface (MS) of which includes an optically invisible marking image formed by modifying an area of MS by chaining the surface energy of the modified area. Said optically invisible marking image is characterized by the possibility of visualization through the establishment of a meta-stable environment of water vapor in the area of the MS of the object in the process of cooling VO. A visually perceptible image of the optically invisible mark is obtained in the form of distinguished structures formed by stable phase particles of the meta-stable environment at the sites of the MS of VO having different surface energy. The cooling device contains a designated placement location for VO is embodied in the form of Peltier element realizing the Peltier effect. Contacts and of Peltier element are connected to an electrical circuit with adjustable amperage. The designated placement location is located on the external, visually accessible surface of contact of the cooled Peltier element, enabling the placement of VO in an area with a non-homogenous temperature field and the cooling of MS of VO to a temperature below the dew point temperature of water vapor in the environment surrounding MS by controlled changes in the temperature of the Peltier element cooled contact. The device may be equipped with optical means of visual observation of the visualized marking image.

### PERTINENT ART

The invention relates to readout devices for information hidden from visual perception and can be mainly used to visualize hidden images of identification (marks) of an object, which provide protection against unauthorized reproduction (forgery), as well as for research purposes for the visualization of optically invisible structures in the surface layer of an object by variation in surface energy values.

### PRIOR ART

From the prior art, a method is known for creation and visualization of optically invisible marks, according to which the surface area of the protected object (in particular, jewelry in the form of a diamond), by means of a laser beam is formed an image hidden to perception by the naked eye (the protective label), the subsequent visualization of which can be carried out by the use of appropriate optical means (U.S. Pat. No. 4,467,172).

The disadvantages of the known prior art method of visualizing hidden images include its limited field of use, For example, in marking jewelry, particularly diamonds, the geometric parameters of microstructures of the protective labels, subject to visualization by optical means, are so large that they are regarded to be a defect in the product, thereby dramatically reducing its aesthetic properties and value.

There is also a way of creating and visualizing an optically invisible mark, according to which an optically invisible marking image is created on the surface of the object by modifying at least one area of the surface, followed by visualization of the marking image microstructure by etching and subsequent viewing of the image using the strong optical or electron microscope (RU, No. 2073270, C1).

The disadvantages of this known prior art method of creating and visualizing an optically invisible mark, as in the previous case, include the limited field of application because of its applicability only to the special polymer materials in the form of films, as well as the inability to visualize the latent marking images without the use of powerful microscopes.

In addition, the known method does not save the label optically invisible after the first visualization (i.e. visualization by etching).

The closest to the claimed invention is a method of creation and visualization of an optically invisible mark, according to which the surface of the object is first polished. On the polished surface, an optically invisible marking image is formed by modifying at least one area of the surface. As a result of surface modification, the surface energy of modified sites changes. Said marking image is then visualized by means of establishing a meta-stable environment in the vicinity of the aforementioned surface of the object. By means of said environment, the marking image is produced in the form of distinguished structures formed by stable phase particles of the meta-stable environment at the sites of the object surface having different surface energy. (WO 02/089041, C1, EP 1391841).

The disadvantages of the known method include a relatively low contrast of the visually perceived marking image because of the small difference in the surface energy of modified and un-modified surface areas, and hence the image quality being highly dependent on the investigated surface contamination.

Furthermore, during repeat visualization of tags, the marking image may be overlapped by the image of a structure formed by the merger of several centers of condensation and the emergence of new centers during evaporation of the condensate from the previous visualization (FIG. 1). That is, the relatively uniform layer of surface contamination micro-particles (which are always present in the real world visualization) is modified in the event of condensation of droplets on the surface and evaporation of condensate with the formation of randomly distributed micro-particle islets on the examined surface. In the subsequent visualization, these micro-particle islets may become additional functional centers of condensation, distorting the marking image.

### DISCLOSURE OF INVENTION

The basis of the disclosed invention is the task of creating a durable, optically invisible mark (i.e., invisible with the help of any optical microscope), on surface of the object, with high quality visualized image, in particular, high contrast and spatial resolution in the real world environment, with any number of consecutive visualization cycles by means of increasing the density of condensation centers, which form a mark during its visualization, and by reducing the impact of surface contamination on the contrast of the viewed image.

The stated task is solved by utilizing a method of creation and visualization of optically invisible mark, according to which the surface of the object is first polished and an optically invisible marking image is formed on the polished surface by modifying at least one area of the surface; as a result of said surface modification, the surface energy of modified sites changes and said marking image is then visualized by means of establishing a meta-stable environment in the vicinity of the aforementioned surface of the object; by means of said environment, the marking image is produced in the form of distinguished structures formed by stable phase particles of the meta-stable environment at the sites of the object surface having different surface energy, whereby, according to the invention, prior to performing each visualization process of the optically invisible marking image, the surface in question, containing the modified areas, is electrically charged and cleaned by friction.

### BRIEF DESCRIPTION OF DRAWINGS

The invention is illustrated by the following graphics.

FIG. 1—the surface of the object with an optically invisible marking image upon performing the visualization process according to the prototype method.

FIG. 2—the surface of the object with an optically invisible marking image upon performing the visualization process according to the claimed method.

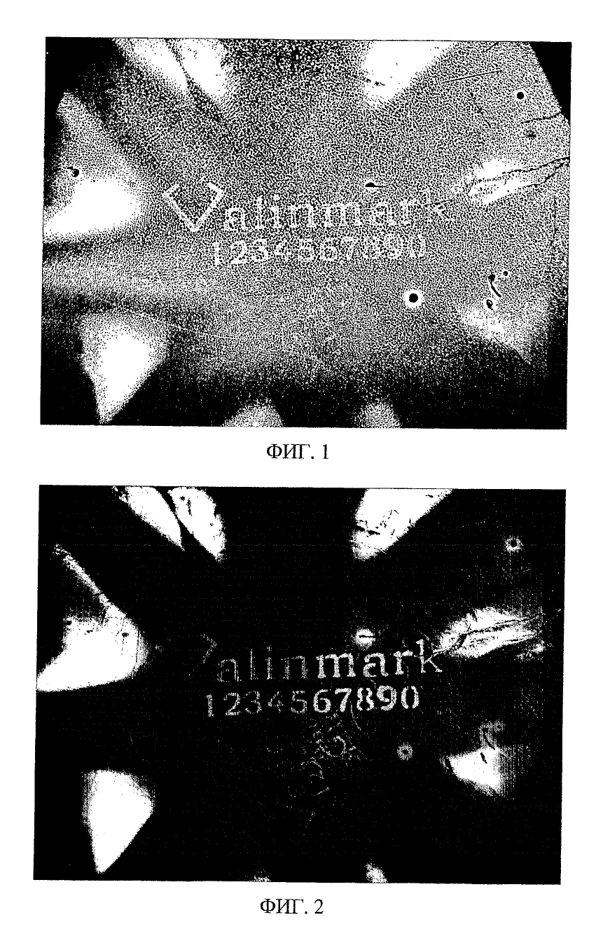

### THE BEST EMBODIMENT OF THE INVENTION

The claimed method is embodied as follows.

The surface of the object is first polished. An optically invisible marking image is formed on the polished surface by modifying at least one area of the surface. As a result of said surface modification, i.e. by changing the composition and/or the structure of the near-surface atomic layers of the object in question, changes the surface energy of modified sites. Concurrently with the changes in surface energy of the modified sites also change the adhesion properties of these sites, being, just as the surface energy, a function of the degree of disbalance of surface charges within the surface in question. Said marking image is then visualized by means of establishing a meta-stable environment in the vicinity of the aforementioned surface of the object. By means of said environment, the marking image is produced in the form of distinguished structures formed by stable phase particles of the meta-stable environment at the sites of the object surface having different surface energy.

The main characteristic feature of the claimed method is that prior to performing a visualization process of the optically invisible marking image, the surface in question, containing the modified areas, is electrically charged and cleaned by friction.

As a result electrically charging the investigated surface, the excess static electricity charge is distributed on this surface in line with the level of local disbalance of surface charges formed in the modification process. This results in enhanced heterogeneity of distribution and increased density of surface charges, which serve as condensation initiators in the process of visualizing the mark. This decreases the dependence of the visualized image contrast on the contamination level of the viewed surface.

Electrical charging through friction results in simultaneous cleaning of the surface, because, as a result of treatment by friction, the microparticle islets of impurities formed after evaporation of condensate from the previous visualization process, and being additional functional centers of condensation distorting the marking image, are removed.

Thus, when performing visualization of the surface with modified sites after electrically charging and cleaning it by friction increases the contrast of the image while reducing the dependence of image quality on the contamination level of the investigated surface.

Supercooled water vapor from ambient air, which is formed when the air contacts the cooled object in question, is typically used as the metastable environment.

Images of structures, formed by stable phase particles of the metastable environment, develop in the form of water droplets on the surface of the object.

The dynamics of stable phase formation on the surface of the object from the metastable environment depends on the free surface energy or the magnitude of adhesion. Within the surface sites with different surface energy, the meta-stable environment converts into stable phase in different ways.

The mark is durable because surface modification of an object, causing changes in its surface energy, obtained, for example, by using spatially modulated metals ion beams (e.g. hafnium, chromium), leads to a stable (including at ambient conditions) change in the composition and structure of the surface with modified surface energy.

An example of a specific embodiment of the claimed method.

A hidden (optically invisible) marking image in the form of inscriptions and figures was formed on the polished surface of diamond sample by modifying the surface of the specimen using the ion beam (hafnium ions), passed through a stencil mask. This is followed by electrical charging and cleaning by friction of the surface in question containing the modified sites. An optical element wiping cloth, enclosed in a dielectric frame, was used for electrical charging and cleaning of the surface. Note that various solvents can be used for cleaning of heavily contaminated surfaces; however, immediately before the visualization of the image, the electrical charging and cleaning of the sample surface is carried out without using any liquids (by dry friction). For visualization of optically invisible image, the sample was put in contact with the cold surface of thermoelectric Peltier element for a few seconds. As a result, water vapor from ambient air condensed on the cooled surface. The optically invisible marking image is visualized in the form of droplets of water condensate distributed in a specific manner on the surface of the object, as shown in FIG. 2 of the graphic materials, showing the visually perceived marking image formed from droplets of water condensate at a 3× magnification.

Tests carried out for one year on the original mark (shown in FIG. 2), revealed no decrease in the image contrast after multiple visualization during the test period. Multiple visualization of the marking image using metastable medium does not turn the optically invisible marking image in a permanently visible one, as is the case, for example, in the prototype method after the optically invisible mark in the polymer film is visualized by the use of alkali etching.

### INDUSTRIAL APPLICABILITY

Thus, the claimed invention may find wide application in various fields of science and technology for the reading/writing information hidden from visual perception. In particular, it can be used for multiple visualization of hidden images (marks) that identify an object and provide protection against unauthorized reproduction (forgery), as well as for scientific research purposes for visualization of optically invisible structures that vary only in their surface energy levels.

1. A device for the visualization of optically invisible marking images, said device comprising means for cooling of the object, the mirror-like surface of which includes and optically invisible marking image formed by modifying at least one area of the surface by changing the surface energy of the modified area, said optically invisible marking image characterized by the possibility of being visualized through the establishment of a meta-stable environment of water vapor in the area of the viewed surface of the object in the process of cooling the object and obtaining a visually perceptible image of the optically invisible mark in the form of distinguished structures formed by stable phase particles of said meta-stable environment at the sites of the object surface having different surface energy, and the cooling device being embodied with a designated placement location for the viewed object, characterized by the device for cooling the object being embodied in the form of Peltier elements realizing the Peltier effect, with the matched contacts of said elements being connected to an electrical circuit with adjustable amperage, and the designated placement location on the cooling device being located on the external, visually accessible contact surface of the cooled Peltier element, enabling the placement of the viewed object in an area with a non-homogenous temperature field and the cooling of mirrored surface of the object to a temperature below the dew point temperature of water vapor in the environment surrounding the viewed surface by controlled changes in the temperature of the Peltier element cooled contact.

2. The device of claim 1, wherein the placement location for the viewed object on the cooling device being located in a closed space, such as a housing, preventing the development of convective currents of ambient gas against the cooled surface of the object, and also being equipped with optical observation devices for the visualized marking images, including and optical system with an eyepiece, arranged with the ability to display the image by means of rays of blue and/or white-blue frequency spectrum reflected from the cooled surface of the viewed object, as well as an autonomous source of directional light, such as an LED, generating this range of frequencies.
